(19) United States
(12) Patent Application Publication
(10) Pub. No.: US 2018/0194417 A1
(43) Pub. Date: Jul. 12, 2018

(54) Magazine, Production Apparatus and Method

(71) Applicant: KUKA Systems GmbH, Augsburg (DE)

(72) Inventors: Marius Jakob, Augsburg (DE); Stefan Mayr, Friedberg (DE)

(21) Appl. No.: 15/740,601

(22) PCT Filed: Jul. 4, 2016
(86) PCT No.: PCT/EP2016/001138

§ 371 Date: Dec. 28, 2017

(30) Foreign Application Priority Data
Jul. 3, 2015 (DE) 202015103526.8

(51) Int. Cl. B62D 65/18; B23K 31/02; B23K 37/047; B23P 21/00

(52) U.S. Cl. CPC B62D 65/18; B23K 31/02; B23K 2201/006; B23P 21/004; B23K 37/047

(57) ABSTRACT

A magazine for a framing station, wherein the movable, in particular rotatable, magazine has a plurality of distributed holding points for clamping frames and a controllable positioning device, which moves the magazine having the desired clamping frames into a transfer position. The positioning device moves the magazine on multiple axes. A method of operating a production apparatus having such a magazine includes transporting at least one workpiece along a conveying direction through a process area of the production apparatus, and feeding at least one clamping frame inside the process area to an associated workpiece. The feeding takes place by rotatory and translational displacement of the clamping frame.

### CROSS-REFERENCE

This application is a national phase application under 35 U.S.C. § 371 of International Patent Application No. PCT/EP2016/001138, filed Jul. 4, 2016 (pending), which claims the benefit of German Patent Application No. DE 20 2015 103 526.8 filed Jul. 3, 2015, the disclosures of which are incorporated by reference herein in their entirety.

### TECHNICAL FIELD

The invention relates to a magazine for a framing station of an automated assembly line.

### BACKGROUND

WO 2006/094631 A1 discloses a rotatable magazine with several circumferentially distributed receiving stations for clamping frames. Said magazine is used for a framing station for tack welding or finish welding the shells of vehicle bodies. The magazine rotates about a single upright axis and is brought by a positioning apparatus with the desired clamping frame into a respective transfer position with respect to a transport apparatus, with which the clamping frames can be transported to a welding area.

### SUMMARY

The object of the present invention is to provide an improved magazine technology and a correspondingly improved operating method.

The aforementioned object is achieved by means of a magazine exhibiting the features disclosed herein.

The claimed magazine technology, i.e., the magazine and the associated operating method, have different advantages. The multi-axially movable positioning apparatus make it possible to achieve improvements in terms of the space requirement and in terms of the interfering contour of the movable magazine. When said magazine is used in conjunction with a production apparatus with a transfer line for workpieces, in particular, the shells of vehicle bodies, the magazine can be arranged in a space saving manner and with better functionality. In particular, its own interfering contour can be kept outside the interfering edges of the workpiece transport and a station frame. Nevertheless, little space in the transverse direction to the transfer line is required. On the whole, the space requirement of the production apparatus and the one or more magazines thereof can be significantly improved, in particular, reduced or functionally better distributed. Space intensive dead spaces can be avoided.

The positioning apparatus imparts to the magazine during the movement thereof and, in particular, precisely one rotatory component of motion and an, in particular, precisely one translational component of motion. A rotatory component of motion consists of a rotation about an axis of rotation, while a translational component of motion consists of a linear displacement along a straight axis of translation. Therefore, the combination of two components of motion can be described as a multi-axis motion. As a result, when used in conjunction with the said production apparatus, on the one hand, the respectively required receiving stations for a clamping frame can be rotated into the transfer position to a transport apparatus. On the other hand, a movement stroke can be executed transverse to and away from the transfer line simultaneously. This is particularly advantageous for the aforementioned freedom of interfering contours.

The movement of the magazine and the positioning apparatus, employed for this purpose, can be designed in various ways. It is particularly advantageous, if the positioning apparatus executes two or more superimposed rotatory motions about discrete and distanced axes of rotation. Rotatory motions are easy to control and to guide and provide a well-defined kinematics. In addition, the receiving station, particularly in the form of a receiving rail, can be connected in a particularly advantageous way to a transport path of the transport apparatus and can be routed into a corresponding path gap.

The axes of rotation can be oriented in parallel and have a mutual offset. Preferably the axes of rotation are oriented vertically; and the magazine is formed like a table and rotates about vertical axes. As an alternative, it is also possible to arrange the axes horizontally and to form the magazine in a drum shape or in any other structural shapes and kinematics.

The positioning apparatus has preferably an eccentric means. For this purpose, the parallel axes of rotation are particularly advantageous. The eccentric means allows each receiving station of the rotating magazine to be brought in a space-saving manner into the same transfer position. In addition, a positioning apparatus can make do with an eccentric means having a single controllable positioning drive. For this purpose, it is advantageous for the positioning apparatus to have a motion transmission that is coupled to the positioning drive.

A toothed gear system with meshing ring gears, which roll on each other and have varying diameters as well as distanced axes of rotation, is particularly advantageous for this purpose. The number of receiving stations at a magazine can vary and can be adapted to the specific needs or purpose. In this case the aforementioned motion transmission can be easily adapted. Such a motion transmission runs extremely accurately and reliably as well as quietly. It also offers convenient bearing options with high supporting force, particularly in the form of spherical rotary connections, which can easily absorb the stresses, particularly the tilting moments, resulting from the various loading conditions of the magazine.

As an alternative, other forms of motion transmission are possible, for example, link mechanisms. In addition, a motion transmission can be simplified or omitted, where in this case the positioning apparatus has, for example, a plurality of positioning drives, which are interdependently controlled.

The magazine or, more specifically, the positioning apparatus can comprise a preferably controllable locking device. This locking device ensures that the clamping frame occupies the transfer position at each receiving position. This arrangement increases the operational reliability when loading or unloading clamping frames or when changing frames. It is particularly advantageous to form the magazine with a rotary frame and a carrier, which is rotatably mounted on said rotary frame. Said carrier has the receiving stations for the clamping frames as well as the aforementioned motion transmission.

In addition, one aspect of the present invention relates to a method for operating a production apparatus, wherein the method comprises the following steps:

transporting at least one workpiece along a conveying direction through a process area of the production apparatus;

feeding at least one clamping frame inside the process area to an associated workpiece, wherein the feeding takes place by means of, in particular, a simultaneous, rotatory and translational displacement of the clamping frame.

Preferably, the production apparatus comprises a movable magazine for accommodating the at least one clamping frame. In this case the magazine can be shifted in order to deliver the clamping frame. The shifting movement of the magazine can take place multi-axially, so that, in particular, a rotatory and translational motion can take place at the same time.

Additional advantageous embodiments of the invention are herein.

### BRIEF DESCRIPTION OF THE DRAWINGS

The invention is shown in schematic form by way of example in the drawings. The accompanying drawings, which are incorporated in and constitute a part of this specification, illustrate exemplary embodiments of the invention and, together with a general description of the invention given above, and the detailed description given below, serve to explain the principles of the present invention.

FIG. 1 shows a perspective view of a production apparatus with several magazines.

FIGS. 2, 3, and 4 show a side view, a front view and a top view respectively of the production apparatus from FIG. 1.

FIG. 5 shows a magazine in a perspective view.

FIG. 6 shows a top view of the magazine from FIG. 5.

FIG. 7 shows a cross section of the magazine from FIGS. 5 and 6.

FIG. 8 shows a fragmentary and enlarged detailed view of the broken-open magazine and the positioning apparatus thereof.

FIG. 9 shows in schematic form a representation of the magazine and its positioning apparatus with the corresponding kinematics and interfering contour.

### DETAILED DESCRIPTION

The invention relates to a magazine (7-10) for clamping frames (6) and to an associated operating method. Furthermore, the invention relates to a production apparatus (2), which is equipped with one or more such magazines (7-10), as well as a production facility (1), which is equipped with one or more such production apparatuses (2).

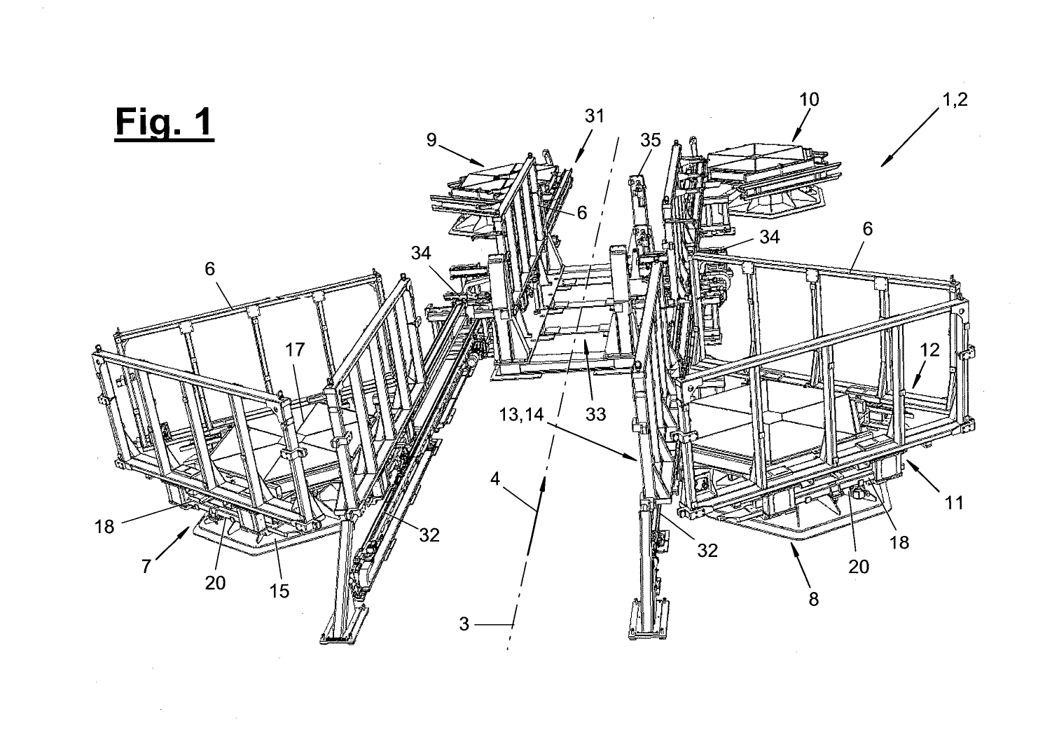

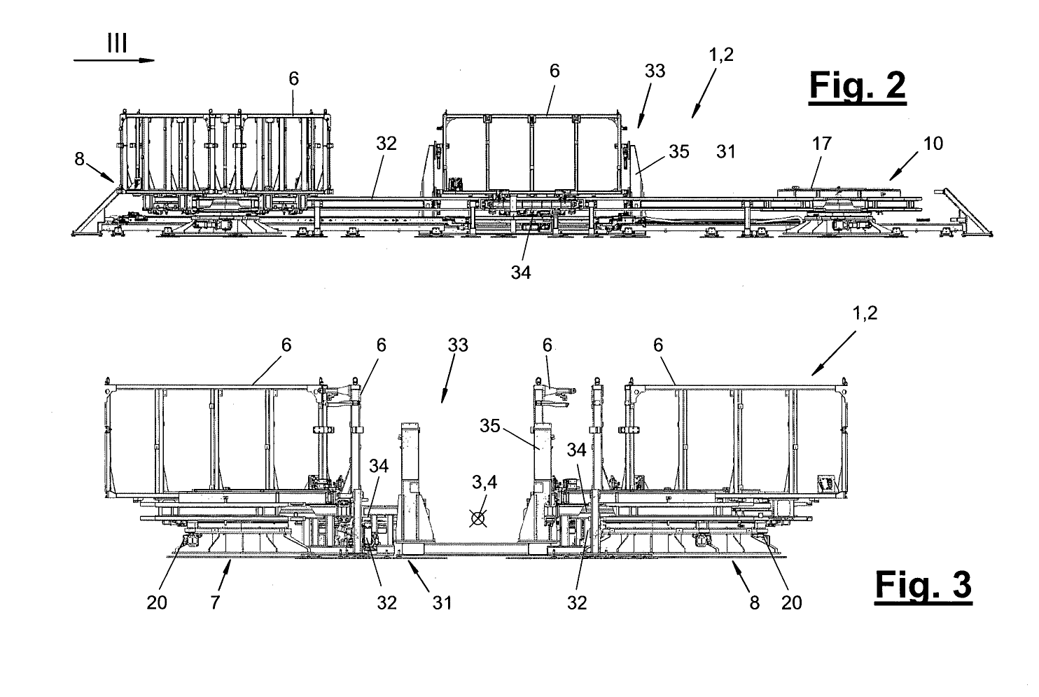

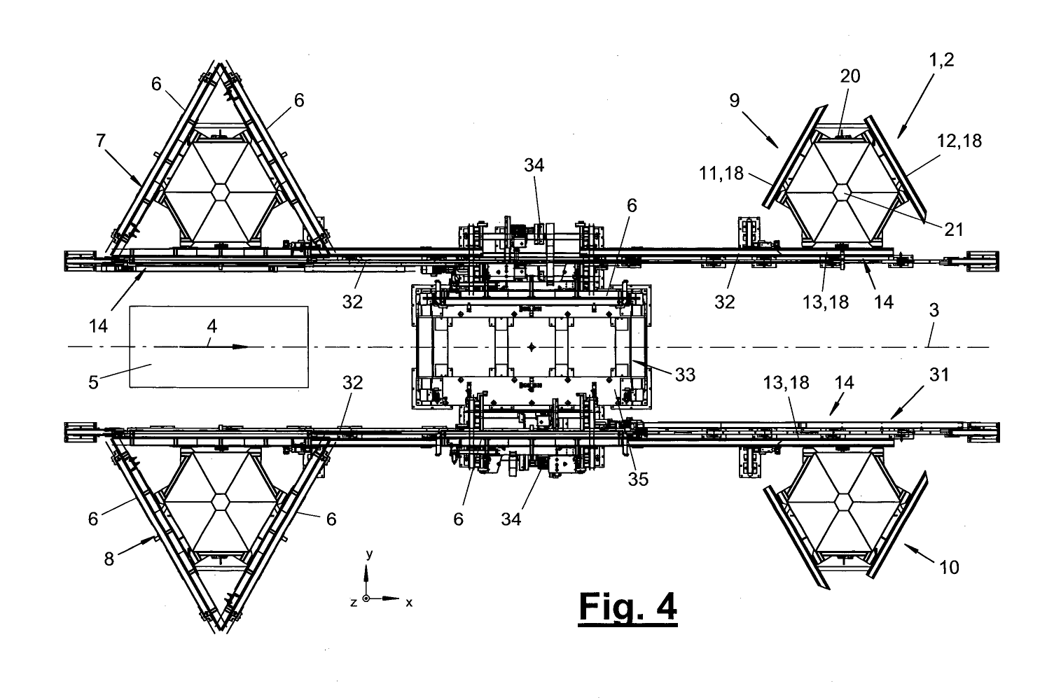

FIGS. 1 to 4 show a production apparatus (2) in different views. In the exemplary embodiment that is shown, said production apparatus is designed as a framing station and works with changeable clamping frames (6) that can be delivered to a process area (33), in particular, a joining area, on workpieces (5) that are transported along a transfer line (3) with a conveying direction (4) through the production apparatus (2) and the process area (33). The conveying movement is carried out in accordance with the coordinate system of FIG. 4 in the x axis. In the process area (33) on the workpieces (5) any process can be performed by a local processing device (not shown), for example, several joining or welding robots.

The workpieces (5), indicated in schematic form in FIG. 4, can be the body parts of a shell of a vehicle body. For example, in this example, said body parts are the side wall parts, floor parts and, if the occasion arises, roof parts, or the like, which are transported on a pallet or any other carrier by means of a suitable conveying device along the transfer line (3) in the conveying direction (4) and are received and accurately positioned in the process area (33). A clamping frame (6) can be fed to one or both longitudinal side(s) of the body parts in the y direction, and with this clamping frame the body parts of the vehicle are clamped in a precisely defined spatial position as well as relative position. A clamping frame (6) may be configured, for example, as a rectangular frame and may comprise a plurality of controllable clamping means.

In the production apparatus (2) there are a plurality of different clamping frames (6), each of which is adapted to each type of body or vehicle. The different types of vehicle bodies or workpieces are transported in a selectable and variable mix on the transfer line (3). With each change of type, the clamping frame(s) (6) is/are also changed in the process area (33).

For the storage of the various clamping frames (6), one or more magazines (7-10) are provided, each of which comprises a plurality of receiving stations (11, 12, 13) for a clamping frame (6). Preferably the magazines (7-10) have in each case two, three or four receiving stations (11, 12, 13). Said receiving stations are disposed in a uniform distribution preferably on the outer periphery of the magazine (7-10). The magazines (9, 10) are shown without the clamping frames (6) for the sake of clarity.

In order to change the clamping frame, a transport apparatus (31) is provided, each having a transport path (32), for example, a transport rail, which connects a magazine (7-10) to the process area (33). The magazines (7-10) have a transfer position (14), which is connected to the transport path (32) and at which a loading and unloading of a clamping frame (6) at a local receiving station (11, 12, 13) can take place. The clamping frames (6) are guided by means of drives along the transport path (32) in a tilt resistant manner and at the same time can be arranged in such a manner that they hang or stand upright.

In the embodiment shown, for example, four magazines (7-10) are arranged on both sides of the transfer line (3) and in the conveying direction (4) respectively in front of and behind the process area (33) and a local station frame (35).

The transport path (32) extends between the lined-up magazines (8, 10) and the station frame (35), an arrangement that requires a feed apparatus (34).

The transport apparatus (31) has a continuous transport path (32) on each side of the transfer line (3), which extends in the x direction and connects the respective magazines (7, 9) and (8, 10) to the process area (33) as well as to each other. By means of a feed apparatus (34), the clamping frame (6) can be fed from the respective transport path (32) in the y direction transverse to the transfer line (3) to the process area (33) and can be docked and fixed there in a defined, precise position on the station frame (35) for the joining process, particularly a welding process.

Furthermore, the transport apparatus (31) comprises a controllably driven and as circumstances require a plurality of existing transport means (not shown), with which the clamping frames (6) can be transported along the leading transport path (32) and can be coupled to and decoupled from the transfer positions (14) of the magazines (7-10).

The magazine (7-10) are preferably identical in design. Said magazines are movable, in particular, rotatable, and comprise a controllable positioning apparatus (20), which brings the receiving stations (11, 12, 13) with the desired clamping frame (6) into the transfer position (14), where they are brought preferably into floating alignment with the transport path (32). In this way, the clamping frame (6) that is required in each case can be made ready for pickup or can be received on an empty receiving station (11, 12, 13). The magazines (7-10) can be moved, in particular, rotated reversibly or unidirectionally.

The receiving stations (11, 12, 13) are identical in design and comprise, in each case, a suitable receiving means (18) for a single clamping frame (6). The receiving means (18) is designed, for example, as a straight rail section with a guide contour that corresponds to the transport path (32). Said receiving means can receive the clamping frame (6) in a standing or hanging manner on its drive. In addition, controllable supporting and locking means (not shown) may be provided for each clamping frame (6) that is received at the receiving stations (11, 12, 13). The transport path (32) terminates at the region of the transfer position (14) or has here a path gap. The receiving means (18) is suitably contoured at the ends for docking at the transfer path (32) or fitting into the path gap, and at the same time the magazine kinematics are considered accordingly.

The positioning apparatus (20) moves the magazine (7-10) about several axes of motion. In particular, the positioning apparatus (20) imparts to the magazine (7-10) during the movement thereof a rotatory and translational component of motion. With the rotatory component of motion the receiving stations (11, 12, 13), which are distributed in a circle over the periphery of the magazine, are rotated into the transfer position (14). In this case the translational component of motion causes a displacement in a direction transverse to the transfer line (3) or the conveying direction (4). The translational component of motion can be effected by a translational motion or, as shown in the exemplary embodiments, as the result of one or more rotatory motions.

In this respect FIG. 9 illustrates the outer interfering contour (36) of the magazine (7-10), with said interfering contour resulting from the movements of the magazine. Said interfering contour deviates from a circular shape, which can be found in the prior art and which is shown by means of the dashed dotted lines in FIG. 9 for comparison purposes. In particular, the interfering contour, caused by the positioning apparatus (20), is significantly flatter than the circular contour in the y direction transverse to the transfer line (3) and the conveying direction (4).

Compared to a conventional magazine, which is positioned at the same place, the interfering contour (36) does not extend into the transport region of the workpieces or, more specifically, the vehicle bodies (5) and ends in front of the respective axial interfering edge (37) of the workpiece transport.

On the other hand, thanks to the positioning kinematics, the transfer position (14) and the orientation of the transport path (32) can be moved close to an axial interfering edge (38) of the station frame (35) in the direction transverse to the transfer line (3). The production apparatus (2) and the changing apparatus, which is formed by the magazines (7-10) and the transport apparatus (31) as well as the feed apparatus (34), for changing the clamping frame can be built very compact and with a small space requirement.

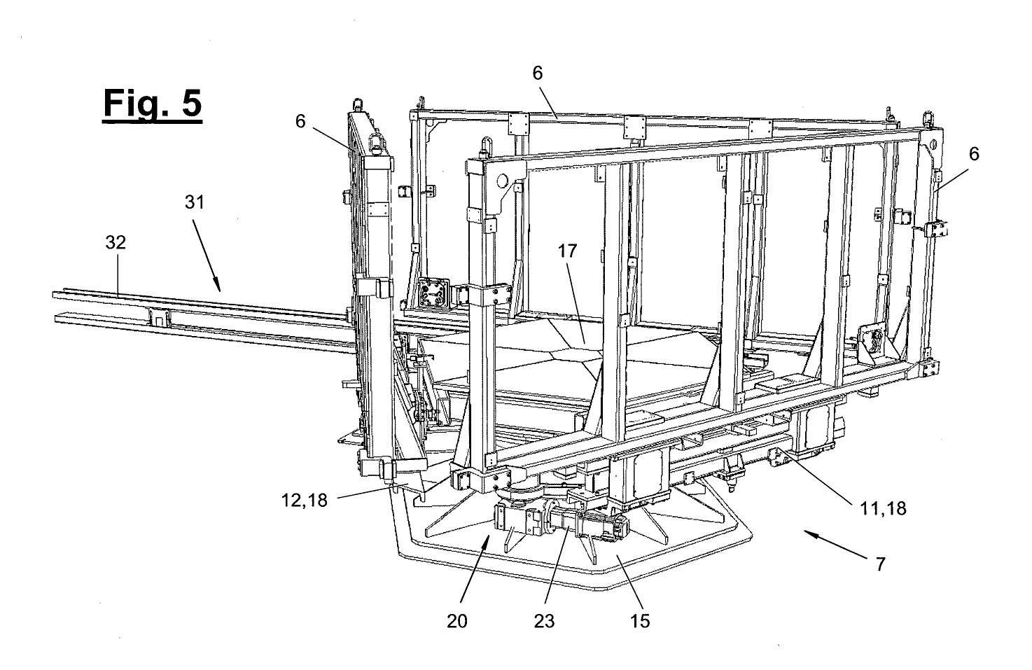

In the exemplary embodiments shown, the magazines (7-10) are designed in the manner of a turntable and execute at least one rotatory component of motion about the upright or, more specifically, vertical z axis. Each magazine has a base (15) and a rotary frame (16) mounted thereon. A carrier (17) is rotatably mounted on the rotary frame (16). On the periphery of said carrier, the carrier has the receiving stations (11, 12, 13) and the respective receiving means (18) in a uniform annular distribution. The carrier (17) may be formed in the shape of a plate or a frame. The base (15) is formed, for example, by a structural base, which is anchored, preferably stationarily, to the ground, particularly the internal flooring of the industrial building. The rotary frame (16) may be designed as a turntable with a horizontal frame or a platform for receiving the carrier (17). FIGS. 5 to 8 illustrate this embodiment in detail.

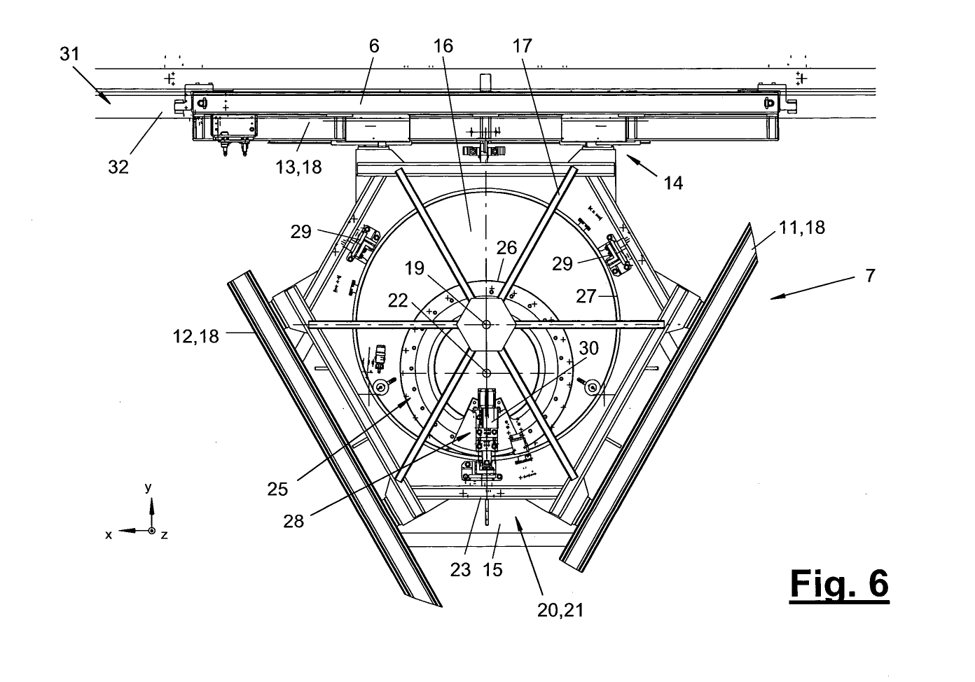

In the preferred embodiments that are shown, the positioning apparatus (20) executes two or more superimposed rotatory motions about discrete and distanced axes of rotation (19, 22). The axes of rotation (19, 22) are arranged parallel and are spaced apart in the y direction transverse to the transfer line (3) or, more specifically, in the conveying direction (4). The axes of rotation (19, 22) are oriented upright or, more specifically, vertically in the z direction. FIGS. 6 to 9 show this arrangement.

The positioning apparatus (20) has an eccentric means (21). Relevant for this purpose are the parallel axes of rotation (19, 22) and their aforementioned distance, which causes the eccentricity (e), shown in FIG. 9.

The rotary frame (16) rotates about the axis of rotation (22). The carrier (17), which is rotatably mounted on the rotary frame (16), rotates in turn around the other axis of rotation (19) relative to the rotary frame (16). In this way, the eccentric means (21) is formed.

The two rotatory motions about the axes of rotation (19, 22) are preferably superimposed on each other. Furthermore, said rotatory motions are also preferably derived from one another. For this purpose, the positioning apparatus (20) comprises a controllable positioning drive (23) and a motion transmission (25), which is coupled to the positioning drive (23). Said motion transmission acts, for example, between the rotary frame (16) and the carrier (17). In the illustrated embodiments, a single positioning drive (23) is sufficient.

As an alternative, the rotatory motions can be generated separately and independently of each other by separate positioning drives. Said positioning drives can be controlled in mutual dependency. In such a variant, a motion transmission can be omitted or simplified. A superimposed rotatory motion of the eccentric means (21) can also be generated, if necessary, by a discrete sequence of individual rotatory motions, where in the end effect the carrier (17) is moved and positioned by means of several, particularly by two rotatory motions. In another variant, the number of axes of rotation and rotatory motions may be larger than two.

The receiving stations (11, 12, 13) can be brought one after the other into the same transfer position (14) by means of the positioning apparatus (20). For such a full cycle of the magazine the rotary frame (16) executes a plurality of full rotations of 360 degrees each about its axis of rotation (22), whereby the carrier (17) executes a single full rotation of 360 degrees about its own central axis of rotation (22), which is eccentric with respect to the axis (19). The number of these full revolutions of the rotary frame (16) corresponds to the number of receiving stations (11, 12, 13).

In the illustrated form with three receiving stations (11, 12, 13), the rotary frame (16) executes three full revolutions. In this case, with each revolution a different receiving station (11, 12, 13) is brought into the transfer position (14), located opposite the transfer line (3). For such kinematics, the stationary axis of rotation (22) of the rotary frame (16) is further away from the transfer line (3) or the transport path (32) than the concomitantly moved eccentric axis of rotation (22) of the carrier (17). FIG. 9 shows this arrangement in the starting position.

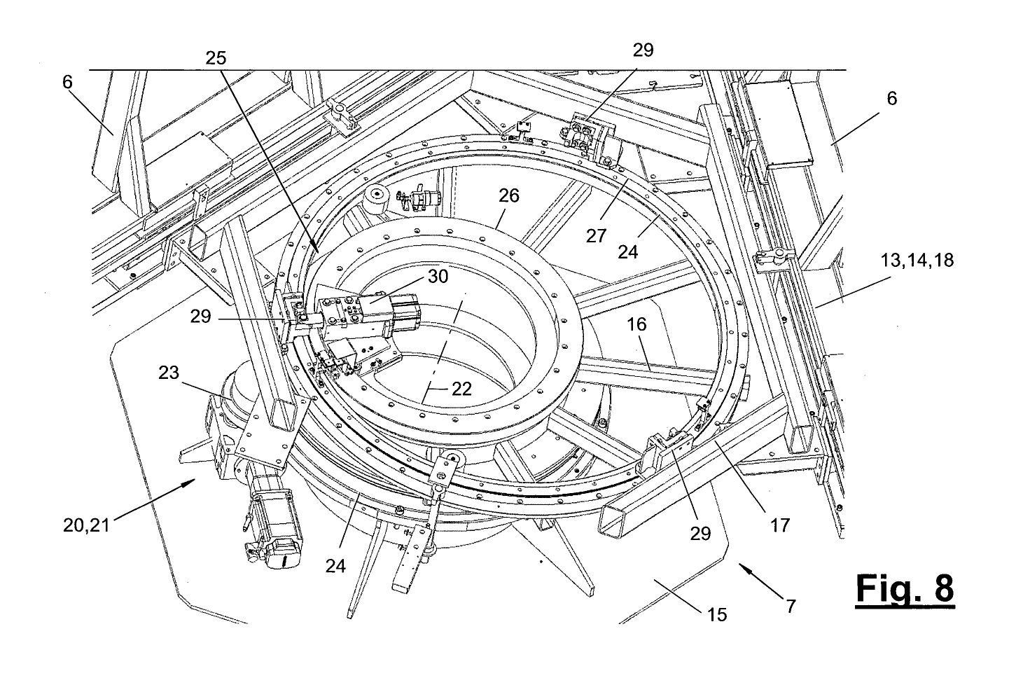

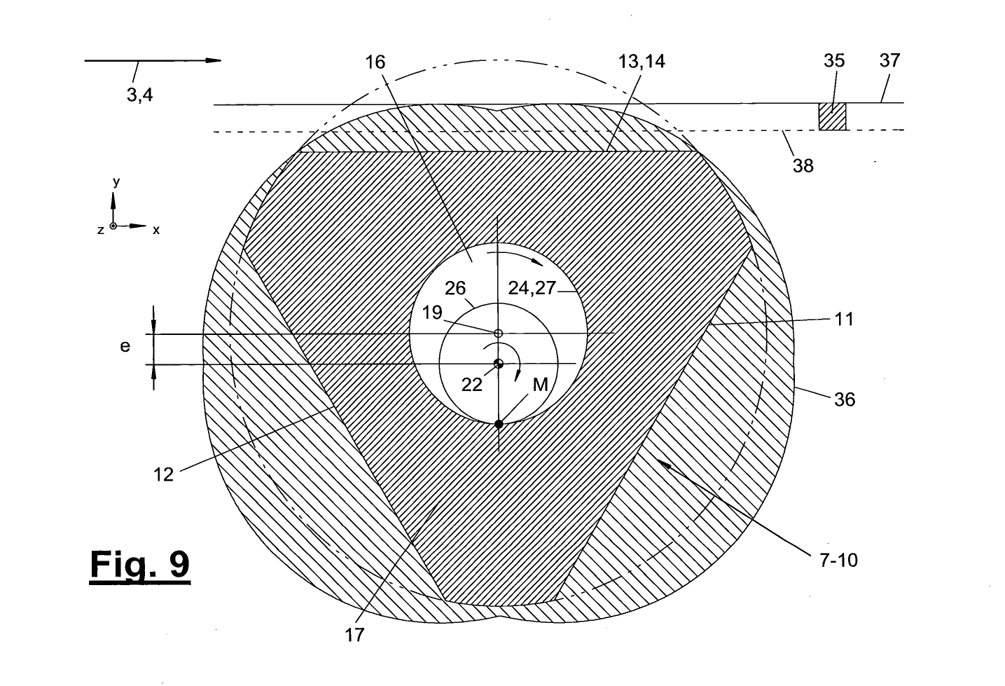

For the illustrated embodiment of the positioning apparatus (20) with the eccentric means (21) and the motion transmission (25), the positioning drive (23) is arranged stationarily on the base (15) and acts on the rotary frame (16). The rotary frame (16) consists, according to FIG. 8, of a lower ring section, which is supported on the base with a rotatable bearing (24). The ring section is arranged and oriented so as to be concentric with the axis of rotation (22). The positioning drive (23) engages at the ring section and turns it about the axis of rotation (22).

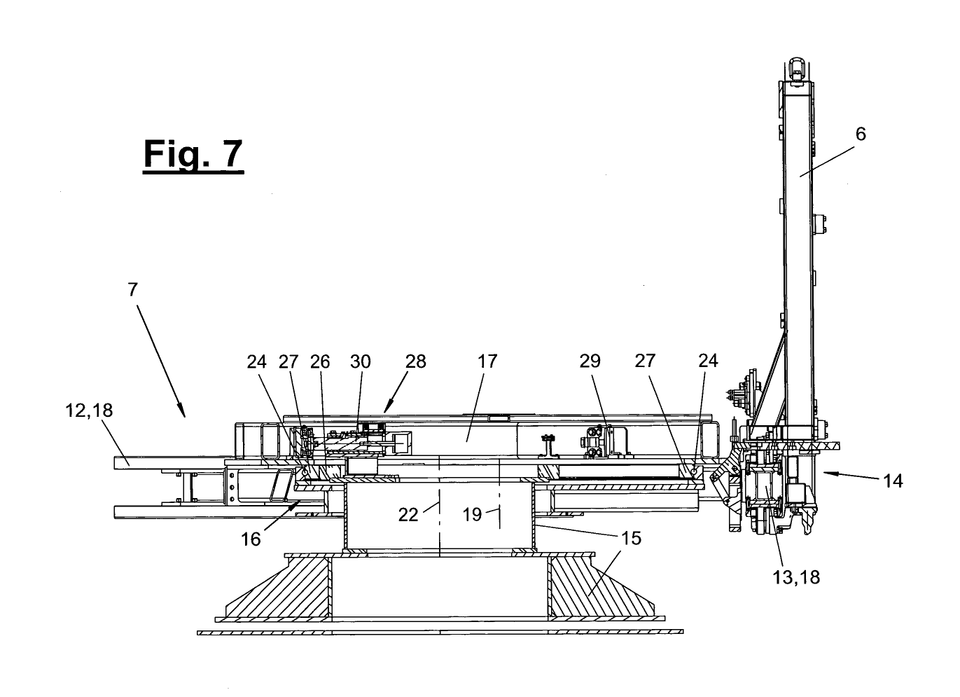

At the upper end the ring section is connected to a frame-like or plate-like frame member, which is oriented horizontally and transverse to the axis (22) and which is configured preferably so as to be non-rotatoryly symmetrical and is used to receive the eccentrically arranged carrier (17). FIG. 8 shows this arrangement with carrying arms, which radially adjoin the ring section. Each carrying arm bears on its free end an annular bearing (24) for the carrier (17). This bearing (24) is oriented so as to be concentric with the second eccentric axis of rotation (19). The carrier (17) in turn is formed as a frame-shaped or plate-shaped frame and is supported on the said annular bearing (24). The bearings (24) are designed, for example, as annular rolling bearings, in particular, as ball bearing slewing connections. The bearing (24) of the carrier (17) is shown in the cross section of FIG. 7, where in this case the rotary frame is not shown for the sake of clarity and is symbolized by an arrow.

In the illustrated and preferred embodiment, the motion transmission (25) is designed as a toothed gear system. It consists of two meshing circular ring gears (26, 27), which roll on each other and have varying diameters as well as the said axes of rotation (19, 22), which are spaced apart. An inner, smaller ring gear (26) is arranged stationarily on the base (15) and has external toothing. Said inner ring gear is arranged inside the ring section of the rotary frame (16) so as to be concentric with the stationary axis of rotation (22) and is supported on the base. The second outer and larger ring gear (27) is provided with an internal toothing. Said outer ring gear is mounted rotatably about the axis (19) with respect to the stationary inner ring gear (26) and rolls on said inner ring gear.

The rolling movement occurs during a rotatory motion of the rotary frame (16) and the concomitantly moved eccentric axis (19) about the stationary axis (22). This rotatory motion takes the outer ring gear (27) with it at the same time and, in so doing, causes said outer ring gear in turn to rotate and roll on the inner ring gear (26). At the same time the instantaneous center M, formed at the contact point of the gear rings (26, 27), of the rotatory motion and the contact point move in the circumferential direction on the stationary inner ring gear (26).

Owing to the different size and arrangement of the ring gears (26, 27) the outer ring gear (27) executes the aforementioned single full rotation about its own central axis of rotation (19) upon several full rotations of the rotary frame (16).

The positioning apparatus (20) has a preferably controllable locking device (28) for the carrier (17). Said locking device is provided and is effective for the respective preferably positive locking of the receiving stations (11, 12, 13) in the transfer position (14). As a result, the magazine (7-10) is fixed relative to the transport apparatus (31) during loading and unloading of a clamping frame (6).

The locking device (28) can be formed in different ways. Said locking device has movable and stationary locking elements (29, 30). The number of movable locking elements (29) may correspond to the number of receiving stations (11, 12, 13). The movable locking elements (29) are arranged on the carrier (17) and have an annular distribution, corresponding to the receiving stations (11, 12, 13), about the central axis (19). In this case each locking element is located diametrically opposite the associated receiving station (11, 12, 13) with respect to the axis (19). In this respect, the movable locking elements (29) are arranged so as to be distributed in a circle on the larger ring gear (27) or on the annular bearing (24) of the carrier (17). When said carrier reaches the transfer position (14) during the aforementioned multiple rotations of the carrier (17), each associated locking element (29) moves into the locking position.

The stationary locking means (30) is present and arranged preferably individually. As an alternative, an array arrangement is possible. The stationary locking means (30) is arranged at the locking position opposite the transfer position (14), and is supported stationarily on the base (15). This is done in the illustrated exemplary embodiment by means of an arrangement on the stationary ring gear (26).

The locking function can be effected by a form-fitting engagement of the locking means (29, 30). In the embodiments shown, the moveable locking means (29) have a radially directed receiving opening, into which a locking pin, located on the stationary locking means (30), can be inserted. The locking pin is movable and is acted upon by a spring for safety reasons and is moved out. Said locking pin snaps into the respective receiving or locking opening by itself. In order to release and pull back the locking pin, a suitable drive, which is controllable and, for example, pneumatic, may be employed.

The exemplary embodiments, which are shown, illustrate a preferred and claimed embodiment of the invention. The invention extends beyond this and can also be used for other purposes and in other configurations. The magazines (7-10) form in a generalized sense a holding apparatus, which can be designed in other embodiments in other ways. The clamping frames (6) form the functional parts in the generalized sense. In the said other variants of the holding apparatus (7-10) said clamping frames may be designed in other ways, such as tools, workpieces or the like.

In this context, a holding apparatus (7-10) may be used to feed or remove such a functional part (6) to or from a transfer position (14) for any purpose and for any other arrangement. Instead of a transport path (32), it is possible to arrange, for example, a robot or any other manipulator at the transfer position (14). Said robot then removes or feeds a functional part (6), supplied by the holding apparatus (7-10) and in turn is in connection with another process area, for example, an assembly station or the like. A holding apparatus (7-10) can also be used for assembly purposes by arranging a container or an additional compartment to be loaded, optionally also a workpiece, in the region of the transfer position (14), for example.

In an additional modification, the receiving means (18) may be formed in other ways and may be adapted to the functional parts (6). Said receiving means may also receive and bear several functional parts (6). In addition, a receiving means (18) can have its own kinematics and a separate feed apparatus or a drive, in order to effect the transfer or takeover.

In the embodiment shown, the production apparatus (2) is designed as a framing station, where in the process area (33) the workpieces (6) are joined, in particular welded. This process can be a tacking of initially loose vehicle body parts or body parts, which can be moved relative to each other and then clamped. In another embodiment, an already tacked shell of a vehicle body can be finish welded by means of the clamping frames (6). Furthermore, one or more other workpiece parts, in particular, body parts of vehicles, can be fed into the production apparatus (2). This can be done by means of separate feed apparatuses with direct access to the process area (33) or by means of a transfer, which takes place elsewhere, in particular, in the magazine area, to a clamping frame (6).

Furthermore, in another embodiment of the production apparatus (2) the number and arrangement of the magazines (7-10) or in general the holding apparatuses may vary. In a further embodiment, a separate return with a return path for clamping frames (6) or functional parts may be present between the holding apparatuses or, more specifically, the magazines (7-10); and this return path is arranged and oriented additionally and preferably parallel to the transport path (32).

Modifications of the exemplary embodiments, which are shown and described, are possible in a number of different ways. In particular, the features of the exemplary embodiments and the aforementioned variants may be combined in any way with one another, in particular, may also be exchanged.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE NUMERALS AND SYMBOLS

1 production facility
2 production apparatus, framing station
3 transfer line
4 conveying direction
5 workpiece, vehicle body
6 clamping frame, functional part
7 holding apparatus, magazine
8 holding apparatus, magazine
9 holding apparatus, magazine
10 holding apparatus, magazine
11 receiving station
12 receiving station
13 receiving station
14 transfer position
15 base, base frame
16 rotary frame, turntable
17 carrier
18 receiving means, rail
19 center, axis of rotation
20 positioning apparatus
21 eccentric means
22 axis, the axis of rotation
23 positioning drive, rotary drive
24 bearing, ball bearing slewing connection
25 transmission
26 ring gear, stationary
27 ring gear, rotating
28 locking device
29 locking element, movable
30 locking element, stationary
31 transport apparatus
32 transport path, transport rail
33 process area, joining area
34 feed apparatus
35 station frame
36 interfering contour, magazine
37 interfering edge, workpiece transport
38 interfering edge, station frame
M instantaneous center
e eccentricity

1-25. (canceled)

26. A movable magazine for a framing station, comprising:
a plurality of distributed receiving stations for clamping frames; and
a controllable positioning apparatus operable to move the magazine with the desired clamping frame into a transfer position;
wherein the positioning apparatus moves the magazine multi-axially.

27. The magazine of claim 26, wherein the positioning apparatus imparts a rotatory component of motion and a translational component of motion to the magazine during its movement.

28. The magazine of claim 26, wherein the positioning apparatus executes two or more superimposed rotatory motions about discrete and spaced apart axes of rotation.

29. The magazine of claim 28, wherein the axes of rotation are oriented parallel to one another.

30. The magazine of claim 26, wherein the positioning apparatus comprises an eccentric motion device.

31. The magazine of claim 26, wherein the positioning apparatus comprises a controllable positioning drive.

32. The magazine of claim 31, wherein the positioning apparatus comprises a motion transmission coupled to the positioning drive.

33. The magazine of claim 32, wherein the motion transmission comprises meshing ring gears which roll on each other, the respective ring gears having different diameters and spaced apart axes.

34. The magazine of claim 33, wherein the meshing ring gears comprise a first, inner ring gear that is stationary and has external gear teeth, and a second, outer ring gear larger than the first ring gear, the second ring gear having internal gear teeth and is rotatably mounted and rolls on the first, inner ring gear.

35. The magazine of claim 34, wherein the first, inner ring gear is arranged and oriented concentric with a stationary axis of rotation about which the positioning apparatus executes a rotatory motion.

36. The magazine of claim 34, wherein the second, outer ring gear is mounted for rotation about two parallel axes of rotation about which the positioning apparatus executes two or more superimposed rotatory motions.

37. The magazine of claim 34, wherein the second, outer ring gear executes multiple full rotations about an eccentric stationary axis of rotation and a single full revolution about a central axis of rotation of the second ring gear when the magazine rotates 360 degrees.

38. The magazine of claim 37, wherein the number of rotations of the outer ring gear about an eccentric stationary axis of rotation corresponds to the number of receiving stations.

39. The magazine as claimed of claim 37, further comprising:
a rotary frame; and
a carrier mounted on the rotary frame for eccentric rotation relative to the rotary frame;
wherein the receiving stations are circumferentially arranged relative to the rotary frame.

40. The magazine of claim 39, wherein the rotary frame is rotatably mounted about the stationary axis of rotation, and the carrier is rotatably mounted about the central axis of rotation.

41. The magazine of claim 39, wherein the carrier is connected to the second outer ring gear.

42. The magazine of claim 39, wherein the rotary frame is coupled with a positioning drive of the positioning apparatus.

43. The magazine of claim 39, wherein the positioning apparatus comprises a locking device for the carrier, the locking device arranged and configured for locking a respective receiving station in the transfer position relative to the carrier.

44. The magazine of claim 26, further comprising a transport apparatus proximate the transfer position and configured for receiving and transporting clamping frames.

45. A production apparatus, comprising:
a movable magazine according to claim 44;
a process area with a station frame; and
a feed apparatus for connecting to the transport apparatus.

46. The production apparatus of claim 45, wherein the moveable magazine comprises an interfering contour that ends in front of an interfering edge of the station frame, the interfering edge oriented along a transfer line extending through the process area for workpieces.

47. A method of operating a production apparatus according to claim 45, the method comprising:
transporting at least one workpiece along a conveying direction through the process area of the production apparatus; and
feeding at least one clamping frame inside the process area to an associated workpiece;
wherein the feeding takes place by rotatory and translational displacement of the clamping frame.

48. The method of claim 47, further comprising moving the magazine to feed the clamping frame.
